(19) United States
(12) Patent Application Publication
(10) Pub. No.: US 2024/0373374 A1
(43) Pub. Date: Nov. 7, 2024

(54) EXPOSURE FRAMEWORK FOR CLOCK RESILIENCE

(71) Applicant: Nokia Technologies Oy, Espoo (FI)

(72) Inventors: Pilar ANDRÉS MALDONADO, Aalborg (DK); Troels KOLDING, Klarup (DK); Devaki CHANDRAMOULI, Plano, TX (US); Kari NIEMELÄ, Oulu (FI)

(21) Appl. No.: 18/255,627

(22) PCT Filed: Nov. 15, 2021
(86) PCT No.: PCT/IB2021/060566

§ 371 Date: Jun. 2, 2023

Related U.S. Application Data
(60) Provisional application No. 63/121,657, filed on Dec. 4, 2020.

(51) Int. Cl. H04W 56/00; H04J 3/06

(52) U.S. Cl. CPC H04W 56/001; H04J 3/0641

(57) ABSTRACT

Certain example embodiments provide systems, methods, apparatuses, and computer program products for an exposure framework for clock resilience. For example, certain embodiments may provide a way for a network and an application function (AF) to configure a cellular system for timing resiliency. Certain embodiments may utilize a cellular system exposure framework to exchange timing resiliency configuration between the cellular system and AFs.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for an exposure framework for clock resilience.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

According to a first embodiment, a method may include receiving, by a control plane entity, a request for one or more timing resiliency capabilities for a user equipment, an area of interest, or a time domain. The method may include determining a service area for the request. The method may include requesting a report of the one or more timing resiliency capabilities associated with one or more network entities operating in the service area. The method may include determining the one or more timing resiliency capabilities based on the report and one or more time distribution capabilities. The method may include performing reconfiguration of a timing resiliency.

In a variant, the one or more timing resiliency capabilities may include at least one of: one or more holdover capabilities, a clock diversity order, a clock recovery status, a time distribution performance, or a synchronization source. In a variant, the method may further include checking, based on determining the service area, the request with known time source information. In a variant, the one or more network entities may include one or more user plane entities associated with the service area. In a variant, the method may further include transmitting a timing resiliency response. In a variant, the timing resiliency response may be associated with the request. In a variant, the performing of the reconfiguration may further include performing the reconfiguration of at least one of user plane forwarding, time distribution signaling, event monitoring, or reporting.

According to a second embodiment, a method may include detecting, by a network node, a failure of a clock signal associated with the network node. The method may include switching from the clock signal to another clock signal based on the failure of the clock signal. The method may include transmitting, to a user equipment, an update related to the switching from the clock signal to the other clock signal, the failure of the clock signal, or a status of a time distribution service.

In a variant, the clock signal may include a global navigation satellite system signal. In a variant, the other network signal may include at least one of: another signal available at the network entity, or a precision time protocol transport network signal. In a variant, the method may further include transmitting, to a control plane entity, a report of the failure of the clock signal, receiving a clock replacement request, and the switching from the clock signal to the other clock signal may include switching from the clock signal to the other clock signal based on receiving the clock replacement request. In a variant, the clock replacement request may be associated with the switching from the clock signal to the other clock signal.

In a variant, the method may further include transmitting, to the control plane entity, a clock replacement response associated with the switching from the clock signal to the other clock signal. In a variant, the method may further include transmitting one or more time distribution capabilities associated with the signal prior to detecting the failure. In a variant, the update may include one or more time distribution capabilities. In a variant, the one or more time distribution capabilities may be transmitted using one or more system information blocks or one or more radio resource control messages.

A third embodiment may be directed to an apparatus including at least one processor and at least one memory comprising computer program code. The at least one memory and computer program code may be configured, with the at least one processor, to cause the apparatus at least to perform the method according to the first embodiment or the second embodiment, or any of the variants discussed above.

A fourth embodiment may be directed to an apparatus that may include circuitry configured to cause the apparatus to perform the method according to the first embodiment or the second embodiment, or any of the variants discussed above.

A fifth embodiment may be directed to an apparatus that may include means for performing the method according to the first embodiment or the second embodiment, or any of the variants discussed above. Examples of the means may include one or more processors, memory, and/or computer program codes for causing the performance of the operation.

A sixth embodiment may be directed to a computer readable medium comprising program instructions stored thereon for causing an apparatus to perform at least the method according to the first embodiment or the second embodiment, or any of the variants discussed above.

A seventh embodiment may be directed to a computer program product encoding instructions for causing an apparatus to perform at least the method according to the first embodiment or the second embodiment, or any of the variants discussed above.

### BRIEF DESCRIPTION OF THE DRAWINGS

For proper understanding of example embodiments, reference should be made to the accompanying drawings, wherein:

FIG. 1 illustrates an example of an application function (AF) learning timing resiliency capabilities for a user equipment (UE), according to some embodiments;

FIG. 2 illustrates an example signal diagram for the AF requesting timing resiliency for a UE, according to some embodiments;

FIGS. 3a and 3b illustrate an example signal diagram for the AF requesting timing resiliency for a UE, according to some embodiments;

FIGS. 4a and 4b illustrate an example signal diagram for clock replacement, according to some embodiments;

FIG. 5 illustrates an example flow diagram of a method, according to some embodiments;

FIG. 6 illustrates an example flow diagram of a method, according to some embodiments;

FIG. 7a illustrates an example block diagram of an apparatus, according to an embodiment; and

FIG. 7b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for an exposure framework for clock resilience is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments.” “some embodiments,” or other similar language, throughout this specification refers to the fact that a particular feature, structure, or characteristic described in connection with an embodiment may be included in at least one embodiment. Thus, appearances of the phrases “in certain embodiments.” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or.” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Certain aspects of NR may include a time synchronization framework within a cellular system (e.g., the 5G System (5GS)). For example, NR may be expected to provide a more stand-alone cellular system time synchronization approach with or without the presence of time sensitive networking (TSN). To enable this wider more flexible use of the cellular system for time synchronization, the exposure framework may be adapted to offer the exposure of time synchronization network capabilities and allow applications to influence the time synchronization service. The exposure of time synchronization may consider two different time sources (e.g., the vertical clock and the cellular system as a time source), and one or more methods for synchronization. For the vertical clock or cellular system time, a generic precision time protocol (gPTP) client or a PTP client and a (g) PTP protocol may convey the timing information via a user plane. For cellular system time, synchronization may be performed via a radio layer (e.g., a third generation partnership project (3GPP) radio layer) via a control plane (e.g., radio resource control (RRC) and/or system information block (SIB) 9 (SIB9) signalling).

Time synchronization in a cellular system may offer timing resiliency as a service. One aspect of NR may relate to adapting the cellular system to support time-synchronization and the ability to act as a backup for global navigation satellite system (GNSS) timing services. This may be needed because several services in NR may be dependent on timing provided by GNSS (e.g., telecommunications, finance, transportation, power, utilities, banking, etc.). However, GNSS may not be adequate for mission critical services (e.g., five nines services that are expected to have a reliability of at least 99.999 percent). GNSS time delivery may experience several vulnerabilities due to environmental phenomena, malicious or incidental interference, spoofing, adjacent band interference, etc.

Certain aspects of NR may consider a cellular network (e.g., a 5G network), in combination with a timing resiliency solution that leverages both GNSS and, e.g., fibre-based terrestrial transport networks. These certain aspects may serve as a global wireless timing resiliency solution for GNSS, and may also perform as a stand-alone and alternative time synchronization solution using GNSS for the end-points. These aspects may include the use of the cellular system in connection with other timing technologies as a resilient timing source for end-users in association with, as a back-up to, and/or as alternate to the GNSS. Enhancement to the cellular system may also enable time synchronization resiliency if GNSS or other timing services are compromised.

The provision of timing resiliency from the cellular system may result in some challenges not considered before when configuring time synchronization as a service in NR. The configuration of the resilience may impact the UE and may also impact how the cellular network is configured. Particularly, for the network side, there may be a need for new mechanisms to offer this clock resilience framework. As such, these mechanisms may not only focus on how to distribute information between the UE and the network, but may also target how the cellular system can be interconnected (e.g., with its own internal time source and other external time sources) to help ensure certain capabilities. For example, the certain capabilities may be related to which capabilities gNBs have and what synchronization topology the cellular network has. The cellular system framework might not incorporate the configuration of the clock resilience service, which may result in the framework being deficient with respect to, e.g., aspects of applications in terms of clock resilience and how to translate the clock resilience aspects to the configuration of the service in the cellular system.

Some embodiments described herein may provide an exposure framework for clock resilience. For example, certain embodiments may provide a way for the cellular network and AF to configure the cellular system for timing resiliency. Certain embodiments may utilize a cellular system exposure framework to exchange timing resiliency configuration between the cellular system and the AFs. In certain embodiments, the cellular system may be able to determine its own time sources topology (e.g., points of the network connected to different time sources or external time services) for an expected UE service area. Additionally, or alternatively, the cellular system may expose its timing resiliency capabilities to the AF. After the cellular system is aware of its own time sources, it can determine the levels of protection it can offer for timing resiliency as a service. Additionally, or alternatively, the AF may learn cellular system timing resiliency capabilities and may request timing resiliency parameters from the cellular system. The AF can select different levels of protection including one or more configurable timing resiliency parameters (e.g., time synchronization accuracy parameters, validity for time synchronization and/or grand master (GM), time synchronization method to be used (gPTP or PTP), or hold over time requested).

The cellular system may configure the network and network entities (e.g., network nodes, UEs, etc.) to fulfil the AF's and network-agreed parameters. In certain embodiments, this may include the cellular system triggering integrated access backhaul connectivity to obtain timing via backhaul, new control plane Xn associations between gNBs, or user plane N3 tunnels between gNBs and user plane functions (UPFs) to access time sources from different paths. Additionally, or alternatively, the configuration may include the cellular system configuring additional triggers and subscriptions to events for monitoring events at the UEs, gNBs, or cellular core (e.g., 5G core (5GC)) network functions (NFs). Additionally, or alternatively, the cellular system's configuration may include configuring additional network exposure function (NEF) exposure events towards the AF (e.g., clock failure). Additionally, or alternatively, the cellular system's configuration may include configuring the gNBs behavior if a clock fails. For example, the gNBs behaviour may be configured to use a clock switch command or suspending and/or cancelling the time synchronization service based on the clock failure. In certain embodiments, the cellular system could activate the gNBs to use an external (backup) clock as a replacement when GNSS fails. In this way, certain embodiments described herein may improve network operations by providing for timing resiliency configuration and/or clock replacement.

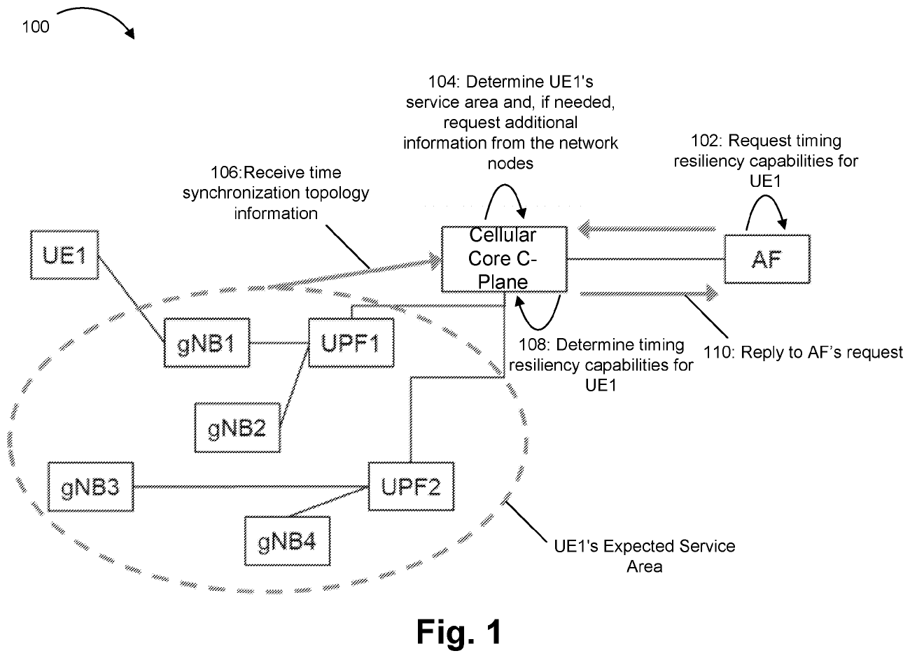

FIG. 1 illustrates an example 100 of an AF learning timing resiliency capabilities for a UE, according to some embodiments. As illustrated in FIG. 1, the example 100 includes a user equipment (shown as UE1), various network nodes (shown as gNB1, gNB2, gNB3, and gNB4), various UPFs (shown as UPF1 and UPF2), a cellular core control plane (C-plane) that comprises various network nodes or is part of a network node (shown as a cellular core C-plane), and an AF. As further illustrated in the example of FIG. 1, the gNB1, gNB2, gNB3, the gNB4, the UPF1, and the UPF2 may be associated with the UE1's expected service area.

As illustrated at 102, the AF may request timing resiliency capabilities for the UE1. For example, the AF may request the timing resiliency capabilities from the cellular core C-plane. Timing resiliency capabilities are described elsewhere herein. As illustrated at 104, the cellular core C-plane may determine the UE1's service area. For example, the service area may comprise a tracking area and may comprise one or more network nodes, such as one or more gNBs and/or one or more UPFs, as illustrated in FIG. 1. In certain embodiments, the cellular core C-plane may request additional information from the network nodes related to fulfilling the request from the AF, as described elsewhere herein.

As illustrated at 106, the cellular core C-plane may receive time synchronization topology information from the network nodes associated with the UE1's service area. For example, the time synchronization topology information may include which network nodes are connected to a time source or an external time service. As illustrated at 108, the cellular core C-plane may determine the timing resiliency capabilities for the UE1. For example, the cellular core C-plane may determine the timing resiliency capabilities based on the time synchronization topology information. As illustrated at 112, the cellular core C-plane may reply to the AF's request. For example, the cellular core C-plane may send the determined timing resiliency capabilities to the AF.

As described above, FIG. 1 is provided as an example. Other examples are possible, according to some embodiments.

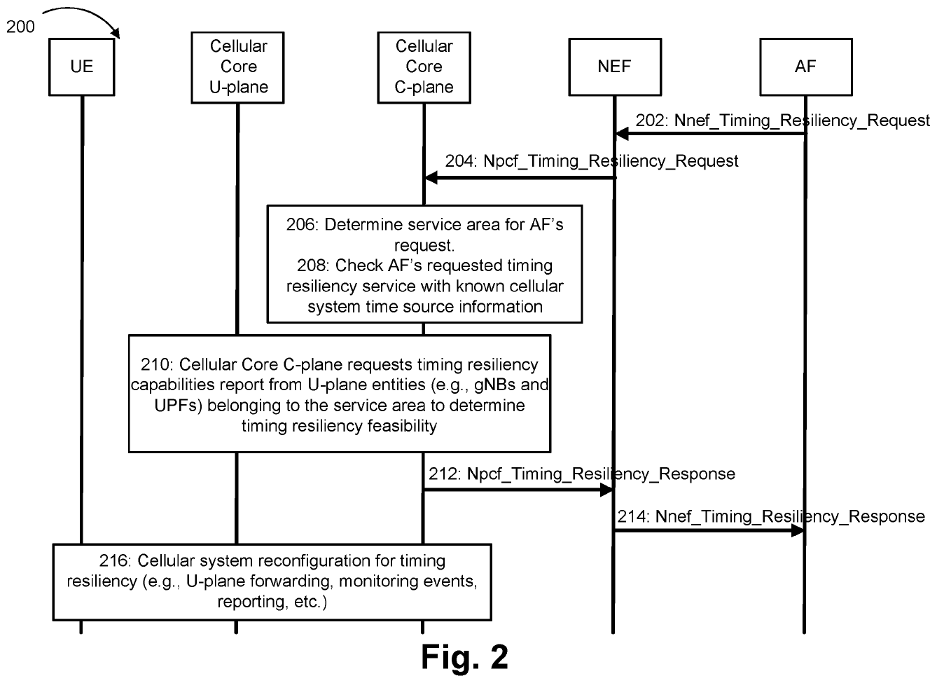

FIG. 2 illustrates an example signal diagram 200 for the AF requesting timing resiliency for a UE, according to some embodiments. As illustrated in FIG. 2, the example signal diagram 200 includes a UE, a cellular core user-plane (U-plane) entity that comprises one or more network nodes (or that is part of a network node), a cellular core C-plane, a NEF, and an AF.

As illustrated at 202, the AF may send a timing resiliency request to the NEF (e.g., illustrated in FIG. 2 as a “Nnef_Timing_Resiliency_Request”). As illustrated at 204, the NEF may send the timing resiliency request to the cellular core C-plane (e.g., illustrated in FIG. 2 as a “Npcf_Timing_Resiliency_Request”). As illustrated at 206, the cellular core C-plane may determine a service area for the AF's request (the timing resiliency request). As illustrated at 208, the cellular core C-plane may determine the AF's requested timing resiliency service with known cellular system time source information.

As illustrated at 210, the cellular core C-plane may request a timing resiliency capabilities report from U-plane entities (e.g., gNBs and/or UPFs) belonging to the service area to determine timing resiliency feasibility. As illustrated at 212, the cellular core C-plane may send a response to the request to the NEF (e.g., illustrated in FIG. 2 as a “Npcf_Timing_Resiliency_Response”). As illustrated at 214, the NEF may send, to the AF, a response to the request (e.g., illustrated in FIG. 2 as a “Nnef_Timing_Resiliency_Response”). As illustrated at 216, certain entities may perform cellular system reconfiguration for timing resiliency (e.g., U-plane forwarding, monitoring events, reporting, etc.). For example, the cellular core C-plane, the cellular core U-plane, and/or the UE may perform the reconfiguration.

As explained above and as illustrated in FIG. 2, the cellular system may be responsible for the timing resiliency configuration, via an exposure framework. In addition, the AF may learn cellular system capabilities to support timing resiliency (e.g., per UE, area, or time domain). Additionally, or alternatively, the AF may request timing resiliency with specified requirements (e.g., per UE or area or time domain, how long the time synchronization and/or domain request will be valid (e.g., immediate, limited duration, anytime), application identifier for which this request should apply, hold over period requested, etc.). Additionally, or alternatively, the AF may supply information that can be used to assist timing resiliency configuration (e.g., the UE's capabilities or additional time sources the UE has outside of a network). Additionally, or alternatively, the AF may request a subscription for events related to a timing resiliency service (e.g., clock failure alarm and/or clock monitoring). Further, based on the operations illustrated in and described with respect to FIG. 2, the cellular core may provide for a timing resiliency server and allowed capabilities. Additionally, or alternatively, a maximum timing resiliency configuration may be allowed per UE, per area of interest (e.g., tracking area code (TAC)), per slice (e.g., network deployment), per time domain or globally, holdover capability, and/or the like.

In certain embodiments, cellular system time sources topology may be determined. The operations, administration, and maintenance (OAM) system may be aware of the external timing service integration within the cellular system (e.g., at the user plane entities that are going to provide resilience service to the end stations, such as NG-radio access network (RAN) nodes or UPFs). The OAM may provide this knowledge as an input to the cellular system (e.g., network data analytics function (NWDAF) and other network functions operating the synchronization service). This may impact the cellular network resource model (NRM) to consider additional requirements for NG-RAN or UPF management.

The timing resiliency capabilities may include holdover capabilities. Holdover capabilities may include how long the cellular system can maintain a patch if there is an issue with the time reference. This capability can be indicated in hours (e.g., the time provision can be maintained valid for X hours) and can have different levels of granularity (e.g., per UE, per area of interest (TAC), per slice (network deployment), per time domain, global, etc.).

Additionally, or alternatively, the timing resiliency capabilities may include clock diversity order and clock recovery status. For example, the clock diversity order and the clock recovery status may include how many time backup mechanisms the UE may have access to before the time reference is lost. This capability can be indicated as an integer (e.g., a diversity order of 2, 3, etc.). This can be used by the application to monitor the level of alarm the synchronization service has. For example, a UE may have access to three independent time backup mechanisms (clock diversity order of 3). In this example, if the first clock source fails, the application may determine that two more are available, so no action is required. Conversely, if another clock source fails, the application may request further actions. Potential examples of clock sources that may provide higher clock diversity orders may include PTP. PTP GNSS, satellite backup, fiber optic cable, intra-cellular system backup, and/or the like.

Additionally, or alternatively, the timing resiliency capabilities may include time distribution performance. Time distribution performance may include an expected transport link performance in terms of jitter, loss, use of synchronous Ethernet (SyncE), etc. Additionally, or alternatively, the time distribution performance may include cellular system synchronization (e.g., alignment of clock frequency) and/or synchronization (alignment on the time of day) service co-play capabilities and inter-GM offset between them. Additionally, or alternatively, the time distribution performance may include expected uncertainty and/or precision for a provided time during fall-back situation.

To determine the holdover capability and the clock diversity order, the cellular system may determine a time backup mechanism status (e.g., monitoring of the clocks of the serving network entities). Additionally, or alternatively, the cellular system may determine potential serving gNB capabilities (e.g., gNB class, holdover capabilities, location, etc.). Additionally, or alternatively, the cellular system may determine synchronization topology within the cellular system (e.g., injection points with external timing services at (R)AN nodes or UPFs). Additionally, or alternatively, the cellular system may determine the UE's synchronization capabilities (e.g., UE's time sources such as Pulse Per Second (PPS), or GNSS receiver, (g)PTP capabilities, and/or the like).

The previously-described resilience capabilities may be highly coupled. For example, to achieve a holdover capability of 24 hours (h), the cellular system may have a clock diversity order of 2. Therefore, the request of one of the parameters may impact the minimum value it can be offered for the remaining timing resiliency configuration parameters. Additionally, the clock resilience exposure may be heavily coupled to the time synchronization service the application has requested from the cellular system.

In this way, certain embodiments described herein may provide for requesting timing resiliency for a UE and/or reconfiguration, which may help to improve operations of a network.

As indicated above, FIG. 2 is provided as an example. Other examples are possible, according to some embodiments.

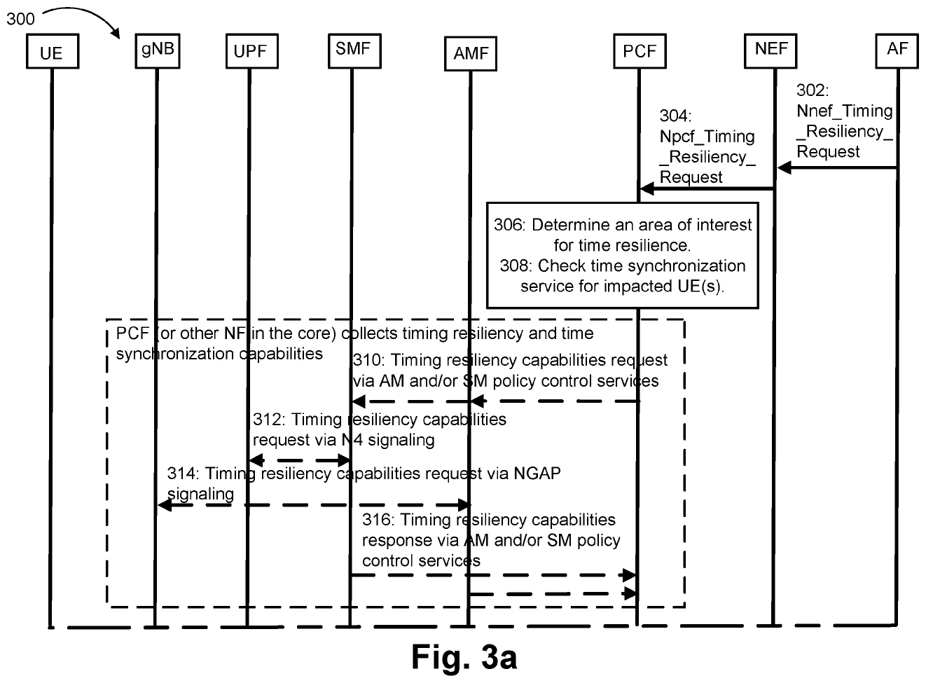

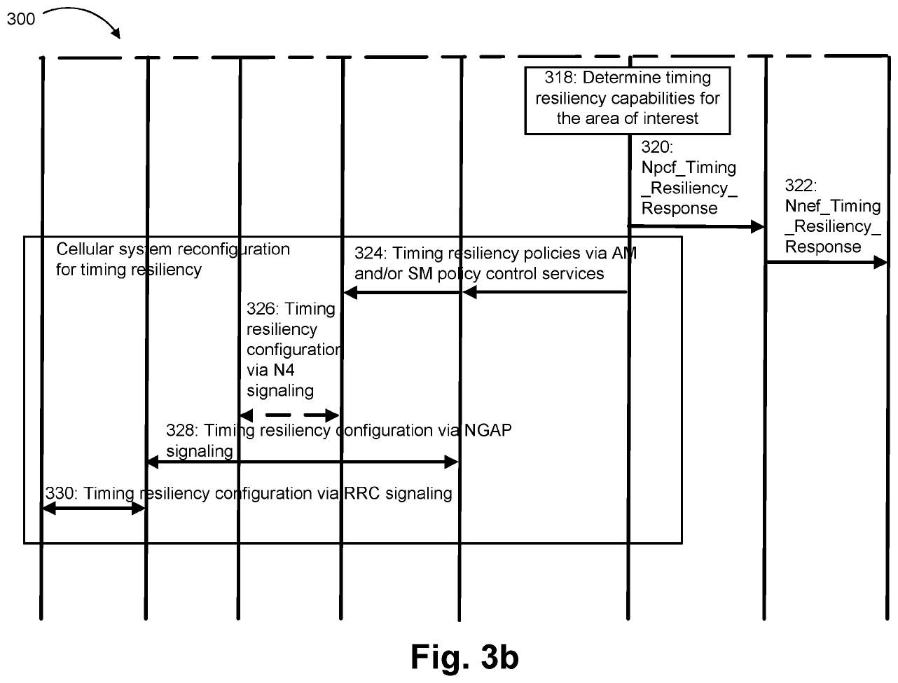

FIGS. 3a and 3b illustrate an example signal diagram 300 for the AF requesting timing resiliency for a UE, according to some embodiments. As illustrated in FIG. 3a, the example signal diagram 300 includes a UE, a gNB, a UPF, a session management function (SMF), an access and mobility management function (AMF), a policy control function (PCF), a NEF, and an AF. As illustrated at 302, the AF may send, to the NEF, a timing resiliency request (e.g., illustrated in FIG. 3a as a “Nnef_Timing_Resiliency_Request”). As illustrated at 304, the NEF may send, to the PCF, the timing resiliency request (e.g., illustrated in FIG. 3a as a “Npcf_Timing_Resiliency_Request).

As illustrated at 306, the PCF may determine an area of interest for timing resilience. As illustrated at 308, the PCF may check a time synchronization service for impacted UE(s).

Operations 310, 312, 314, and 316 may relate to collecting timing resiliency and time synchronization capabilities, which may be performed by the PCF (or another network function (NF) in the cellular core), in certain embodiments. As illustrated at 310, the PCF may send, to the SMF via the AMF, a timing resiliency capabilities request. In this way, the PCF may send the request via access and mobility management (AM) and/or session management (SM) policy control services. As illustrated at 312, the SMF and the UPF may communicate with respect to the timing resiliency capabilities request via N4 signaling. As illustrated at 314, the gNB and the AMF may communicate with respect to the timing resiliency capabilities request via NG application protocol (NGAP) signaling. As illustrated at 316, the SMF and the AMF may send, to the PCF, a timing resiliency capabilities response via the AM and/or SM policy control services.

Turning to FIG. 3b, which illustrates a continuation of the example signal diagram 300, the PCF may, at 318, determine the timing resiliency capabilities for the area of interest. As illustrated at 320, the PCF may send, to the NEF, a timing resiliency response to the timing resiliency request (e.g., illustrated in FIG. 3b as a “Npcf_Timing_Resiliency_Response”). As illustrated at 322, the NEF may send, to the AF, the timing resiliency response (e.g., illustrated in FIG. 3b as a “Nnef_Timing_Resiliency_Response”).

Operations 324, 326, 328, and 330 may relate to a cellular system reconfiguration for timing resiliency. As illustrated at 324, the PCF may send, to the SMF via the AMF, one or more timing resiliency policies via AM and/or SM policy control services. As illustrated at 326, the UPF and the SMF may communicate to perform a timing resiliency configuration via N4 signaling. As illustrated at 328, the gNB and the AMF may communicate to perform the timing resiliency configuration via NGAP signaling. As illustrated at 330, the UE and the gNB may communicate to perform the timing resiliency configuration via RRC signaling.

In this way, certain embodiments illustrated in, and described with respect to, FIGS. 3a and 3b may extend certain embodiments illustrated in, and described with respect to, FIG. 2. For instance, the AF's request at 303 in FIG. 3a may include one or more of: i) the target UE(s) (or a validity area or a time domain (TD)); ii) the information on AF subscription to time resiliency events (e.g., early and/or late notifications, notification for GNSS signal failure, etc.); iii) holdover requirement; or iv) clock diversity requirement. At 306 and 308 in FIG. 3a, the PCF may determine the area of interest for which the AF's request applies. The area of interest together with the time distribution method for the configured time synchronization service (e.g., user plane distribution via (g) PTP messages or control plane distribution) may determine the network entities that may be involved in time resilience service configuration (e.g., the set of gNBs and UPFs).

The operations at 310, 312, 314, and 316 in FIG. 3a may be used to report timing resiliency capabilities and time distribution performance from the gNB(s) and UPF(s) to the PCF (via the AMF and/or the SMF). The involvement of the AMF and/or SMF (and then the use of non-session management related policy control) may vary depending on the time synchronization method used for the impacted UE(s). Timing resiliency capabilities reported at 312 and 314 in FIG. 3a may include the holdover capability, the clock diversity, the description of the time sources the network elements have available, or the expected time distribution performance parameters (e.g., links performance, measurement uncertainty, etc.).

At 318 in FIG. 3b, the PCF may determine timing resiliency capabilities and the policies to apply for the area of interest (e.g., core network (CN)-controlled or RAN-controlled response, event monitoring and reporting between RAN and CN, etc.). Additionally, the PCF may determine the subscription to SMF and/or AMF event notification to later expose these events to the AF. The operations at 324, 326, 328, and 330 in FIG. 3b may be used to configure the NFs for timing resiliency service. With respect to the operation 326 in FIG. 3b, time distribution may just rely on control plane signaling (via SIB9 and/or RRC), so there may be no need to configure the UPF.

As described above, FIGS. 3a and 3b are provided as an example. Other examples are possible, according to some embodiments.

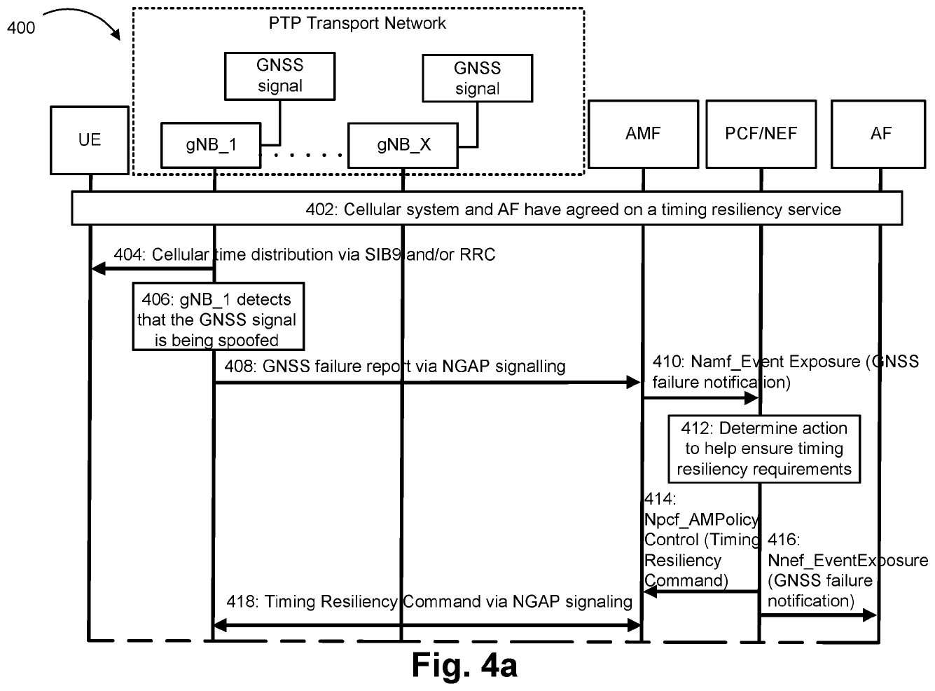

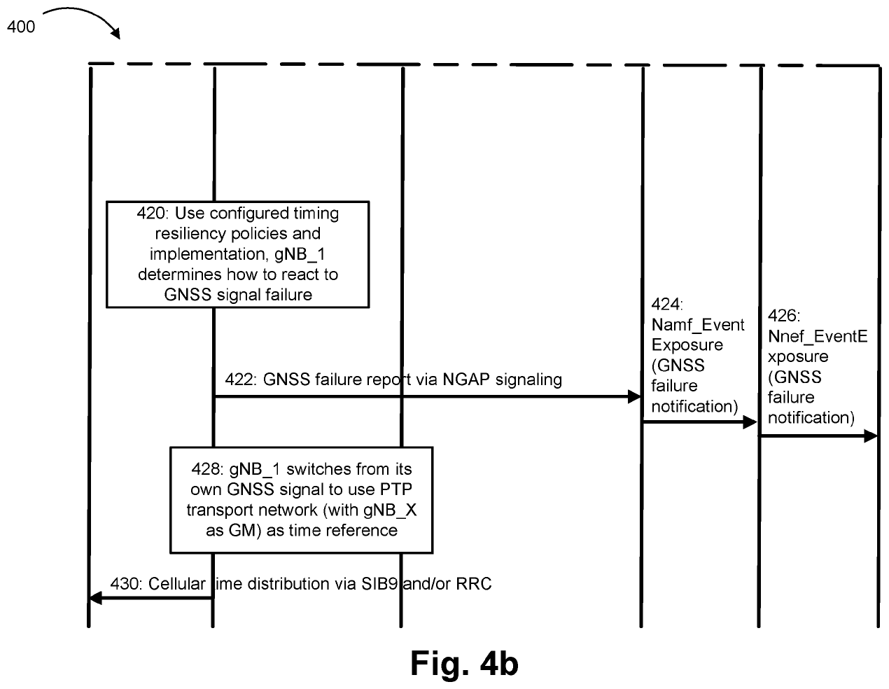

FIGS. 4a and 4b illustrate an example signal diagram 400 for clock replacement, according to some embodiments. As illustrated in FIG. 4a, the example signal diagram 400 includes a UE, various gNBs (e.g., gNB_1 through gNB_X), an AMF, a PCF and/or NEF (shown as “PCF/NEF” in FIG. 4a), and an AF. In addition, the example signal diagram 400 may include a PTP transport network (e.g., a PTP telecommunications industry profile) that provides GNSS signals to the gNBs.

As illustrated at 402, the cellular system and the AF may agree on a configuration for a timing resiliency service. As illustrated at 404, the gNB_1 may transmit, to the UE, a cellular time distribution configuration. The time distribution configuration may be sent via a SIB9 and/or an RRC message. As illustrated at 406, the gNB_1 may detect that the GNSS signal is being spoofed (or another type of failure). As illustrated at 408, the gNB_1 may report the issue to the AMF. As illustrated at 410, the AMF may provide, to the PCF/NEF, a notification of the failure to the PCF/NEF. For example, the AMF may provide a “Namf_EventExposure” notification as a GNSS failure notification.

As illustrated at 412, the PCF/NEF may determine an action to help ensure timing resiliency requirements. As illustrated at 414, the PCF/NEF may send, to the AMF, a timing resiliency command (e.g., illustrated in FIG. 4a as a “Npcf_AMPolicyControl” communication). As illustrated at 416, the PCF/NEF may provide, to the AF, the GNSS failure notification (e.g., illustrated in FIG. 4a as a “Nnef_EventExposure” message). The operations illustrated at 408, 410, 412, 414, 416, and 418, may be associated with CN-controlled timing resiliency, as one option for controlling timing resiliency.

Turning to FIG. 4b, which is a continuation of the example signal diagram 400 on FIG. 4a, the operations illustrated at 420, 422, 424, and 426 may be associated with a RAN-controlled timing resiliency, as another option for controlling timing resiliency. The gNB_1 may, at 420, use configured timing resiliency policies and implementation, where the gNB_1 may determine how to react to the GNSS failure. As illustrated at 422, the gNB_1 may send, to the AMF, a GNSS failure report via NGAP signaling. As illustrated at 424, the AMF may send, to the PCF/NEF, a GNSS failure notification indicating the failure of the GNSS signal (e.g., illustrated in FIG. 4b as a “Namf_EventExposure” message). The PCF/NEF may, at 426, send the GNSS failure notification to the AF (e.g., illustrated in FIG. 4b as a “Nnef_EventExposure” message).

As illustrated at 428, the gNB_1 may switch from its own GNSS signal to using the PTP transport network (with the gNB_X as a GM) as the time reference. As illustrated at 414, the gNB_1 may send, to the cellular core C-plane, a clock replacement response. As illustrated at 430, the gNB_1 may send, to the UE, a cellular time distribution configuration. For example, the gNB_1 may send the time distribution configuration via a SIB9 and/or an RRC message.

As described above and illustrated in FIGS. 4a and 4b, back-up clock switching may be performed at the gNB_1 after a detected GNSS signal failure. In the example of FIGS. 4a and 4b, the cellular core may trigger the clock switch at the gNB_1 (e.g., an access and mobility management function (AMF) may notify the gNB_1 via NG application protocol (NGAP) signalling). Additionally, the clock failure may be report to the AF via the NEF and/or a PCF. Once the GNSS signal failure is detected, the cellular system may instruct the network nodes to switch the clock source (e.g., to an external back up clock or a backup clock from other internal sources, such as a backhaul and/or transport, an Xn/N3 interface, and/or the like). Based on this, the network nodes may adapt reception of time synchronization from a different source. The switch of clocks may include the network updating the UE with an updated cellular reference time in the SIB9 and/or RRC message, as illustrated in FIGS. 4a and 4b. Depending on the time synchronization topology the cellular system has, the preferred time distribution method, and the clock resilience parameters, just the gNBs or the gNBs and UPFs may be impacted by the clock source change. Table 1 summarizes some impact examples at the gNB and/or UPF.

TABLE 1

| | Network Entity Impact | |
|---|---|---|
| New Time Source | gNB | UPF |
| Switch to another time | Change time reference internally and | |
| reference available at | continue time distribution | |
| the network entity | | |
| Switch to another PTP | Change of GM using PTP operation (e.g., | |
| GM available at the | rerunning best master clock algorithm | |
| underlying PTP cellular | (BMCA)) | |
| compatible transport | | |
| network | | |
| Switch to another (g)PTP | gNB has to intercept | When inspecting |
| GM distributed via U-plane | PTP U-plane packets | (g)PTP packets, |
| traffic (behind the N6 | received from UPF/UE | the time reference |
| interface or a UE) | to obtain time reference | is extracted |
| | (e.g., gNB has to read | |
| | the content of the GTP-U | |
| | packets) | |

Certain embodiments of Table 1 may be implemented at the gNB for PTP packets as the gNB may have already support for PTP. However, gPTP support may not be assumed. To enable the gNB to read PTP content and extract the time reference, the gNB may be configured to recognize a quality of service (QOS) flow (e.g., a UL flow for GM at the UE side or downlink (DL) flow for GM at the UPF side). The gNB may be additionally configured to read the protocol data unit (PDU) layer content before forwarding the packet as a service data application protocol (SDAP) and/or general packet radio service tunnelling protocol for user plane (GTP-U) message to the next destination.

As described above, FIGS. 4a and 4b are provided as an example. Other examples are possible, according to some embodiments.

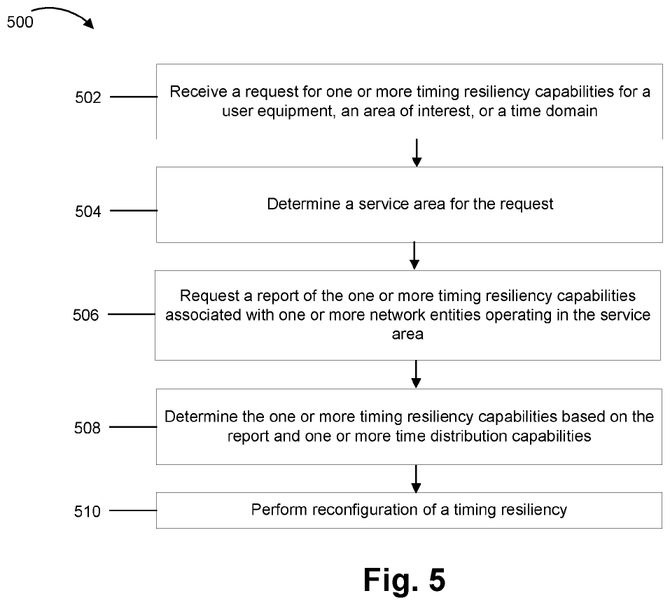

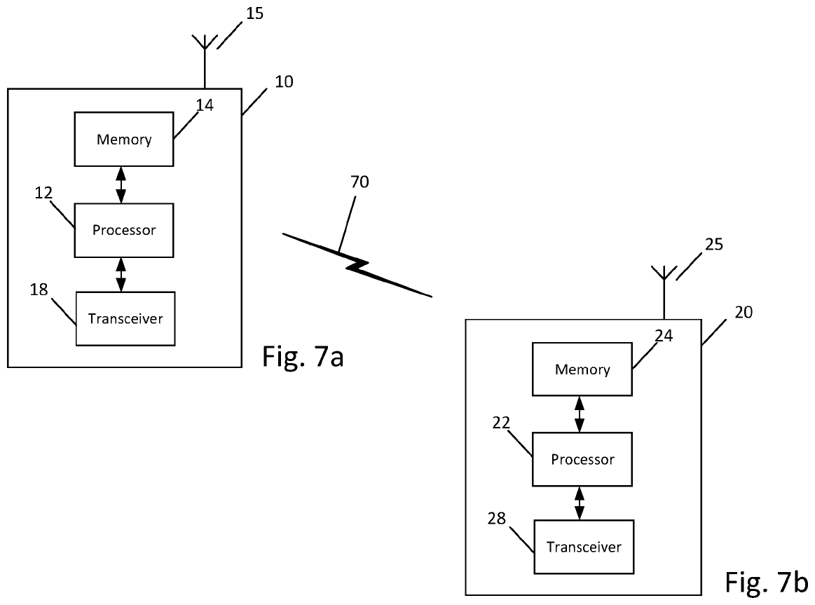

FIG. 5 illustrates an example flow diagram of a method 500, according to some embodiments. For example, FIG. 5 may illustrate example operations of a network node (e.g., apparatus 10 illustrated in, and described with respect to, FIG. 7a). Specifically, FIG. 5 may illustrate certain operations of a control plane entity of a network node. Some of the operations illustrated in FIG. 5 may be similar to some operations shown in, and described with respect to, FIGS. 1-4b.

In an embodiment, the method may include, at 502, receiving a request for one or more timing resiliency capabilities for a user equipment, an area of interest, or a time domain, for example, in a manner similar to that at 102 of FIGS. 1 and/or 204 of FIG. 2. The method may include, at 504, determining a service area for the request, for example, in a manner similar to that at 104 of FIGS. 1 and/or 206 of FIG. 2. The method may include, at 506, requesting a report of the one or more timing resiliency capabilities associated with one or more network entities operating in the service area, for example, in a manner similar to that at 106 of FIGS. 1 and/or 210 of FIG. 2. The method may include, at 508, determining the one or more timing resiliency capabilities based on the report and one or more time distribution capabilities, for example, in a manner similar to that at 108 of FIGS. 1 and/or 210 of FIG. 2. The method may include, at 510, performing reconfiguration of a timing resiliency, for example, in a manner similar to that at 216 of FIG. 2.

The method illustrated in FIG. 5 may include one or more additional aspects described below or elsewhere herein. In some embodiments, the one or more timing resiliency capabilities may include at least one of one or more holdover capabilities, a clock diversity order, a clock recovery status, a time distribution performance, or a synchronization source. In some embodiments, the method 500 may further include checking, based on determining the service area, the request with known time source information. For example, the checking may be performed in a manner similar to that at 208 of FIG. 2.

In some embodiments, the one or more network entities may include one or more user plane entities associated with the service area. In some embodiments, the method 500 may further include transmitting a timing resiliency response. For example, the transmitting may be performed in a manner similar to that at 110 of FIGS. 1 and/or 212 of FIG. 2. In some embodiments, the timing resiliency response may be associated with the request. In some embodiments, the performing at 510 may further include performing the reconfiguration of at least one of user plane forwarding, time distribution signaling, event monitoring, or reporting.

As described above, FIG. 5 is provided as an example. Other examples are possible according to some embodiments.

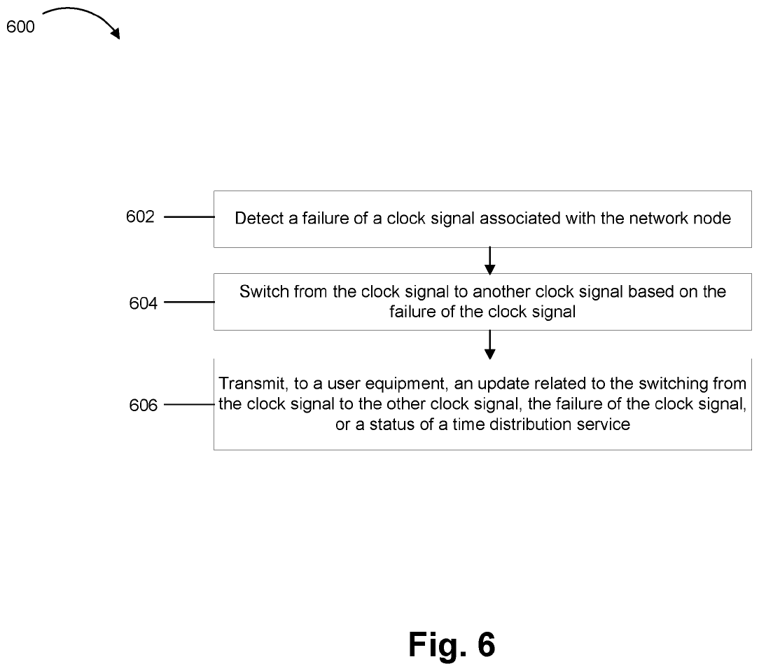

FIG. 6 illustrates an example flow diagram of a method 600, according to some embodiments. For example, FIG. 6 may illustrate example operations of a network node (e.g., apparatus 10 illustrated in, and described with respect to, FIG. 7a). Specifically, FIG. 6 may illustrate certain operations of a gNB. Some of the operations illustrated in FIG. 6 may be similar to some operations shown in, and described with respect to, FIGS. 1-4b.

In an embodiment, the method may include, at 602, detecting a failure of a clock signal associated with the network node, for example, in a manner similar to that at 406 of FIG. 4a. The method may include, at 604, switching from the clock signal to another clock signal based on the failure of the clock signal, for examiner, in a manner similar to that at 428 of FIG. 4b. The method may include, at 606, transmitting, to a user equipment, an update related to the switching from the clock signal to the other clock signal, the failure of the clock signal, or a status of a time distribution service, for example, in a manner similar to that at 430 of FIG. 4b. For example, the network node may inform a UE of a failure of the GNSS signal or any update that may impact time resilience at the UE, then the UE can operate based on implementation or wait for further indication from the cellular system of how to react to that event. Additionally, or alternatively, the network node may provide commands to the UE to perform certain operations (e.g., the clock switching). Additionally, or alternatively, the network node may perform an update regarding the time synchronization service the UE has configured with the cellular system (e.g., there may be a failure in the GNSS signal and the service may no longer be provided, so the time synchronization may be suspended or cancelled for a time period).

The method illustrated in FIG. 6 may include one or more additional aspects described below or elsewhere herein. In some embodiments, the clock signal may include a global navigation satellite system signal. In some embodiments, the other network signal may include at least one of another signal available at the network entity, or a precision time protocol transport network signal. In some embodiments, the method 600 may further include transmitting, to a control plane entity, a report of the failure of the clock signal, for example, in a manner similar to that at 408 and 410 of FIG. 4a. In some embodiments, the method 600 may further include receiving a clock replacement request, for example, in a manner similar to that at 418 of FIG. 4a. The clock replacement request may be associated with the switching from the clock signal to the other clock signal. In some embodiments, the switching at 604 may be based on receiving the clock replacement request.

In some embodiments, the method 600 may further include transmitting, to the control plane entity, a clock replacement response associated with the switching from the clock signal to the other clock signal. In some embodiments, the method 600 may further include transmitting one or more time distribution capabilities associated with the signal prior to detecting the failure. In some embodiments, the update may include one or more time distribution capabilities. In some embodiments, the one or more time distribution capabilities may be transmitted using one or more system information blocks or one or more radio resource control messages.

As described above, FIG. 6 is provided as an example. Other examples are possible according to some embodiments.

FIG. 7a illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G. Additionally, or alternatively, apparatus 10 may comprise a control plane entity and/or a user plane entity, or one or more apparatuses 10 may form a control plane entity and/or a user plane entity.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 7a.

As illustrated in the example of FIG. 7a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 7a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc. USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, control plane entity, user plane entity, or the like.

According to certain embodiments, apparatus 10 may be controlled by memory 14 and processor 12 to perform the functions associated with any of the embodiments described herein, such as some operations illustrated in, or described with respect to, FIGS. 1-6. For instance, apparatus 10 may be controlled by memory 14 and processor 12 to perform the methods of FIGS. 5 and 6.

FIG. 7b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR. 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7b.

As illustrated in the example of FIG. 7b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with any of the embodiments described herein, such as some operations illustrated in, or described with respect to, FIGS. 1-6.

In some embodiments, an apparatus (e.g., apparatus 10 and/or apparatus 20) may include means for performing a method or any of the variants discussed herein, e.g., a method described with reference to FIG. 5 or 6. Examples of the means may include one or more processors, memory, and/or computer program code for causing the performance of the operation.

Therefore, certain example embodiments provide several technological improvements, enhancements, and/or advantages over existing technological processes. For example, one benefit of some example embodiments is improvement to network operations by providing for timing resiliency configuration and/or clock replacement. Accordingly, the use of some example embodiments results in improved functioning of communications networks and their nodes and, therefore constitute an improvement at least to the technological field of timing resiliency, among others.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

5GS 5G System
5GC 5G Core
AMF Access and Mobility Management Function
AF Application Function
BMCA Best Master Clock Algorithm
DN Data Network
GM Grand Master
GNSS Global Navigation Satellite System
gPTP generic Precision Time Protocol
GPRS General Packet Radio Service
GTP-U GPRS Tunneling Protocol for user plane
NEF Network Exposure Function
NRM Network Resource Model
NWDAF Network Data Analytics Function
PPS Pulse Per Second
PTP Precision Time Protocol
RRC Radio Resource Control
SDAP Service Data Adaptation Protocol
SON Self-Organizing Networks
SyncE Synchronous Ethernet
TA Tracking Arca
TD Time Domain
TSN Time Sensitive Networking

1. A method, comprising:
receiving, by a control plane entity of a cellular network, from an application function, a request for one or more timing resiliency capabilities for a user equipment;
determining, by the control plane entity, a service area for the user equipment;
determining, by the control plane entity, the one or more timing resiliency capabilities for the user equipment based on time synchronization topology information associated with the service area for the user equipment; and
transmitting, by the control plane entity to the application function, a response to the request, the response comprising the one or more timing resiliency capabilities for the user equipment.

2. The method according to claim 1, wherein the one or more timing resiliency capabilities comprise at least one of:
one or more holdover capabilities,
a clock diversity order,
a clock recovery status,
a time distribution performance, or
a synchronization source.

3. The method according to claim 1, wherein the time synchronization topology information includes information about which user plane entities of the cellular network operating in the service area are connected to a time source or an external time service.

4. (canceled)

5. The method according to claim 1, further comprising:
performing, by the control plane entity, reconfiguration of the cellular network for timing resiliency.

6. The method according to claim 5 wherein the performing, by the control plane entity, of the reconfiguration of the cellular network for timing resiliency further comprises:
performing, by the control plane entity, reconfiguration of at least one of user plane forwarding, time distribution signaling, event monitoring, or reporting of the user plane entities of the cellular network.

7-18. (canceled)

19. An apparatus, the apparatus comprising:
at least one processor;
at least one memory comprising computer program code of a control plane entity for a cellular network,
the at least one memory and computer program code configured, with the at least one processor, to cause the apparatus at least to perform:
receiving, from an application function, a request for one or more timing resiliency capabilities for a user equipment;
determining a service area for the user equipment;
determining the one or more timing resiliency capabilities for the user equipment based on time synchronization topology information associated with the service area for the user equipment; and
transmitting to the application function, a response to the request, the response comprising the one or more time one or more timing resiliency capabilities for the user equipment.

20. The apparatus of claim 19, wherein the one or more timing resiliency capabilities comprise at least one of:
one or more holdover capabilities,
a clock diversity order,
a clock recovery status,
a time distribution performance, or
a synchronization source.

21. The apparatus of claim 19, wherein the time synchronization topology information includes information about which user plane entities of the cellular network operating in the service area are connected to a time source or an external time service.

22. The apparatus of claim 19, wherein the at least one memory and computer program code are configured, with the at least one processor, to further cause the apparatus at least to perform:
reconfiguring the cellular network for timing resiliency.

23. The apparatus of claim 22, wherein the reconfiguring the cellular network for timing resiliency comprises:
reconfiguring at least one of user plane forwarding, time distribution signaling, event monitoring, or reporting of the user plane entities of the cellular network.

24. A non-transitory computer readable medium comprising program instructions of a control plane entity for a cellular network stored thereon which when executed by at least one processor of an apparatus cause the apparatus at least to perform:
receiving a request for one or more timing resiliency capabilities for a user equipment from an application function;
determining a service area for the user equipment;
determining the one or more timing resiliency capabilities for the user equipment based on the time synchronization topology information associated with the service area for the user equipment; and
transmitting to the application function, a response to the request, the response comprising the one or more time one or more timing resiliency capabilities for the user equipment.

25. The non-transitory computer readable medium of claim 24, wherein the one or more timing resiliency capabilities comprise at least one of:
one or more holdover capabilities,
a clock diversity order,
a clock recovery status,
a time distribution performance, or
a synchronization source.

26. The non-transitory computer readable medium of claim 24, wherein the time synchronization topology information includes information about which user plane entities of the cellular network operating in the service area are connected to a time source or an external time service.

27. The non-transitory computer readable medium of claim 24, wherein the program instructions which when executed by at least one processor of the apparatus further cause the apparatus at least to perform:
reconfiguring the cellular network for timing resiliency.

28. The non-transitory computer readable medium of claim 27, wherein the reconfiguring the cellular network for timing resiliency comprises:
reconfiguring at least one of user plane forwarding, time distribution signaling, event monitoring, or reporting of the user plane entities of the cellular network.
